(19) United States
(12) Patent Application Publication
(10) Pub. No.: US 2018/0089372 A1
(43) Pub. Date: Mar. 29, 2018

(54) IDENTIFYING NON-ROUTINE DATA IN PROVISION OF INSIGHTS

(71) Applicant: Microsoft Technology Licensing, LLC, Redmond, WA (US)

(72) Inventors: Hadas Bitran, Ramat Hasharon (IL); Gil Shacham, Ramat Hasharon (IL); Arie Schwartzman, Tzur Moshe (IL); Ryen William White, Woodinville, WA (US); Tachen C. Ni, Bellevue, WA (US); Girish Sthanu Nathan, Sammamish, WA (US); Elad Yom-Tov, Hoshaya (IL); Jessica Lundin, Seattle, WA (US); Shahar Yekutiel, Tel Aviv (IL)

(73) Assignee: Microsoft Technology Licensing, LLC, Redmond, WA (US)

(21) Appl. No.: 15/280,941

(22) Filed: Sep. 29, 2016

(51) Int. Cl. G06F 19/00; G06F 1/32

(52) U.S. Cl. CPC G06F 19/322; G06F 1/3287

(57) ABSTRACT

Examples are disclosed herein that relate to modifying an analysis of personal behavior based on determining a subset of personal data to be non-routine. One example provides a computing device configured to receive personal data relating to personal behavior of a user, receive contextual data regarding the personal data, determine a subset of the personal data to be non-routine based upon the contextual data, and modify an analysis of personal behavior based upon the subset of the personal data determined to be non-routine.

### BACKGROUND

A computing device may be configured to analyze information regarding user behaviors, such as health and fitness of a person, via data received from sensors and/or user inputs.

### SUMMARY

One disclosed example provides a computing device configured to receive personal data relating to personal behavior of a user, receive contextual data regarding the personal data, determine a subset of the personal data to be non-routine based upon the contextual data, and modify an analysis of personal behavior based upon the subset of the personal data determined to be non-routine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example user interface displaying insights generated from personal data without consideration of non-routine data.

FIG. 2 shows an example user interface displaying insights generated from personal data determined to be non-routine.

FIG. 3 shows a block diagram of an example use environment for analyzing personal data based upon contextual data.

FIG. 4 shows a flow diagram depicting an example method of analyzing personal data based upon contextual data.

FIG. 5 shows a block diagram of an example computing system.

### DETAILED DESCRIPTION

As mentioned above, a computing device may be configured to receive and analyze personal data, such as health- and fitness-related data, for a user. For example, sensor data from a mobile device and/or a wearable device of a user may provide data such as steps taken, calories burned, and heart rate, among others. This data may be analyzed to determine metrics related to workout efficiency, sleep quality and other health-related factors. These metrics may be tracked over time to allow the identification of trends, anomalies, and/or correlations, which may allow the generation of insights (both predictive and historical) regarding the user's health.

However, such devices may not consider when a user has diverged from, is diverging from, or plans to diverge from a routine in a way that may potentially impact such insights. For example, a user may conduct business travel or take vacations that impact day-to-day behaviors such as sleep, work, exercise, and eating habits. Also, a user may deviate from routines on holidays, birthdays, and other special occasions. Likewise, illnesses, medical procedures, and/or other health issues may impact a user's routine behaviors.

Accordingly, examples are disclosed that relate to using contextual information to identify potentially non-routine personal data, and basing an analysis of the personal data on the identification of the potentially non-routine data. Non-routine data may be identified in various manners. For example, non-routine data may be identified from analysis of content generated by or relevant to a user (e.g. calendar data and/or internet search data), from sensor data (e.g. that indicate distances traveled away from a routine location of a user), and/or by user designation of events as non-routine. Likewise, the identification of personal data as non-routine may be used in any suitable manner in an analysis. For example, an analysis may be modified to eliminate the non-routine data from analysis, to give less weight to (or otherwise re-weight) the non-routine data, and/or to perform a separate analysis of the non-routine data. Further, results of an analysis of non-routine data may be used to infer and alert a user of potential future outcomes based upon data that indicates an upcoming non-routine event. While described herein in the context of health data, the disclosed examples may be applied to any other suitable data, including but not limited to work productivity data.

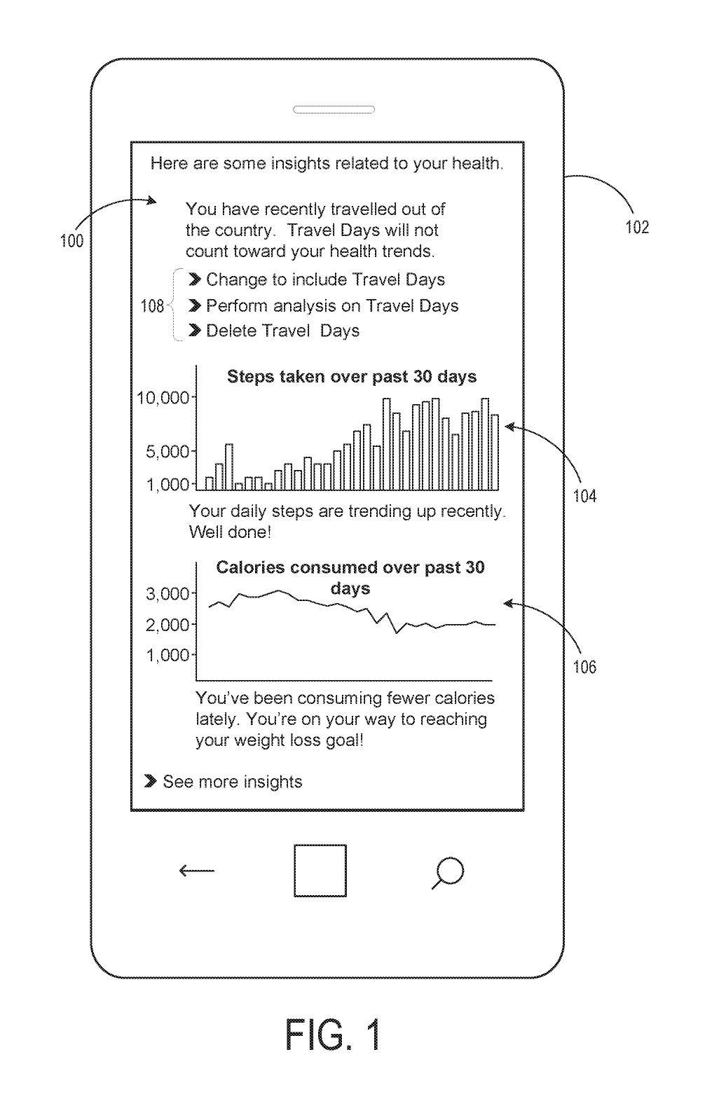

FIG. 1 shows an example user interface 100 on a mobile device 102, and illustrates the display of example insights regarding health data. In this example, data associated with events determined to be non-routine has been previously identified and excluded from the generation of insights. More specifically, health data collected on days determined to be Travel Days (e.g. from analysis of calendar data, transactions with airline websites, location sensor data, etc.) have been omitted in generating insights for the user, such as trends relating to steps taken, at 104, and calories consumed, at 106. The omission of Travel Days data from the generation of the depicted insights may help to avoid impacting analytic trends previously established by the user, such as exercise trends, healthy eating habits, and good sleeping habits. This also may help to avoid presenting information to the user of which the user may already be aware, may be expecting, or may not find relevant.

In some examples, data identified to be potentially non-routine may be automatically excluded from analyses of insights. In other examples, a user may have an option to select whether to exclude data identified as potentially being non-routine from analysis. FIG. 1 illustrates such options in the form of selectable user interface controls 108 that allow a user to select how to treat the data identified as potentially being non-routine. In this example, the options 108 allow the user to select to include data collected on Travel Days, to perform a separate analysis on Travel Days only, or to delete the data from Travel Days.

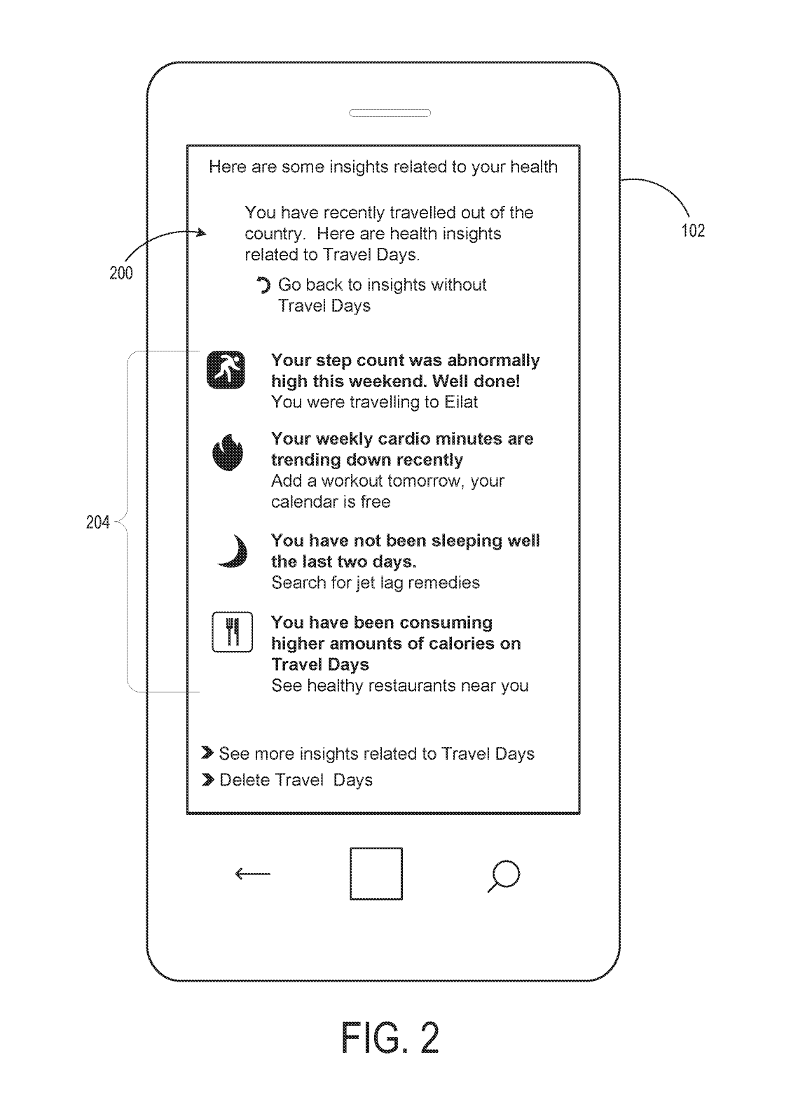

FIG. 2 shows an example user interface 200 that displays example insights regarding health data related specifically to non-routine data. The user interface 200 may be presented, for example, in response to a user input made via options 108 requesting analysis of health data collected on Travel Days. Example insights related to non-routine data are depicted as potential explanations for observed health data (e.g. a higher step count on a travel day), and recommendations related to health effects of the travel (e.g. jet lag remedies based upon detected poor sleep quality and/or suggestions of healthy restaurants nearby the user's travel location in response to detecting that the user has been consuming more calories during Travel Days). In other examples, any other suitable insights may be displayed, and a user interface for displaying such insights may take any other suitable form.

Similar outputs may be provided for determined future Travel Days. For example, the mobile device 102 may determine from calendar data that the user has an upcoming trip to a same/similar location and/or for a same/similar purpose (e.g. business), and output a notification to the user of potential effects of the upcoming trip based upon previous analyses from related past Travel Days.

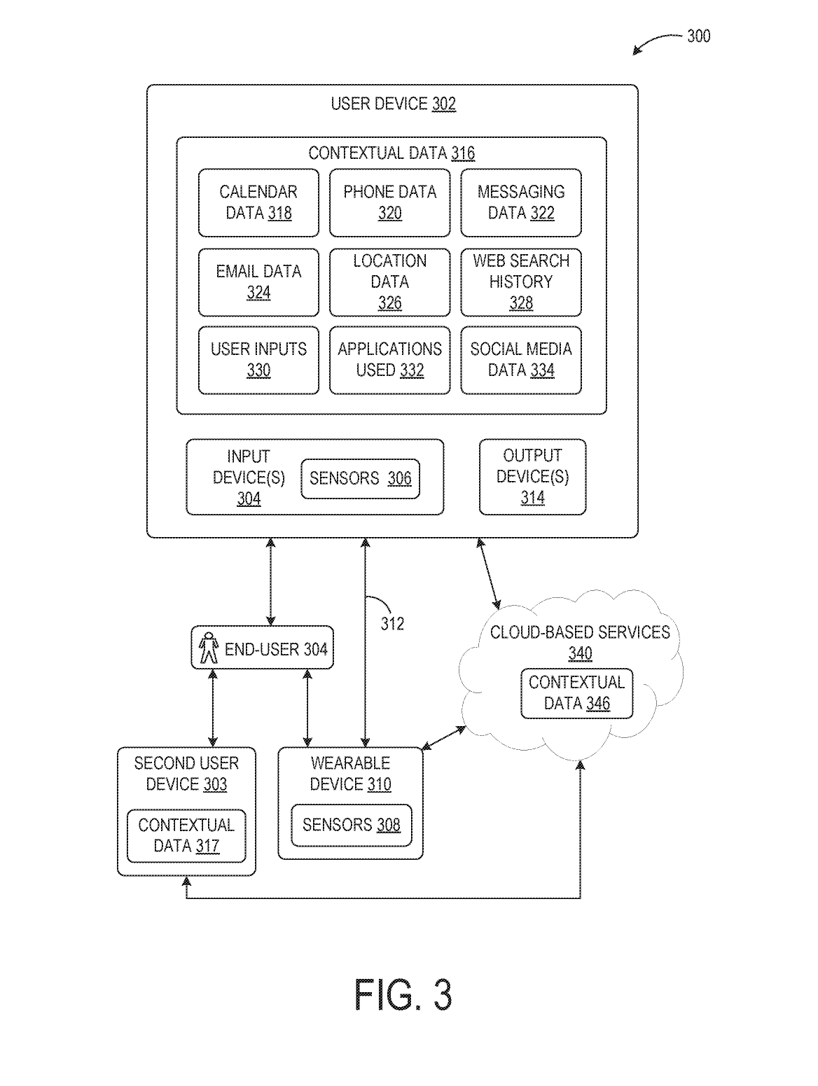

FIG. 3 shows an example use environment 300 providing insights related to personal behaviors based upon determining a subset of personal data to be non-routine. The use environment 300 includes a user device 302 associated with end-user 304. The user device 302 may correspond to any suitable computing apparatus configured to process personal user data, such as health data and work data. Examples include a smartphone, a tablet, a laptop computer, and a desktop computer. Mobile device 102 is an example of user device 302. Other devices also may be associated with the user, as illustrated via wearable device 310 and second user device 303.

The user device 302 includes one or more input devices 304, such as a touch sensor (integrated with or separate from a display), a keyboard (software and/or hardware) and/or a mouse. The input devices 304 also may include one or more sensors 306. Examples of sensors 306 include but are not limited to one or more image sensors (e.g. video camera(s) and/or depth camera(s)), one or more microphones, one or more motion sensors (e.g. accelerometers, gyroscopes, magnetometers, etc.), and a Global Positioning System (GPS) sensor. In other examples, a user device may receive sensor data from sensors residing on another device, such as from sensors 308 on the wearable device 310. Examples sensors 308 may include but are not limited to one or more image sensors, microphones, accelerometers, gyroscopes, magnetometers, an ultraviolet light sensors, an ambient temperature sensor, a galvanic skin response sensor, a skin temperature sensor, an optical heart rate sensor, a GPS sensor, and a barometer. Raw output from such sensors may be analyzed, for example by a computing system of the user device 302 or directly on a wearable device 310, to determine quantities such as user movements, steps taken, heart rate, blood pressure, blood oxygenation, calories burned, and sleep-related characteristics (e.g. a number of and frequency of wakeups, cardiovascular activity during sleep, etc.) as a function of time. This information may then be further analyzed to determine correlations, trends, and other insights. Examples of the wearable device 310 include wrist or ankle-worn devices, head-mounted devices, and clip-on devices, configured to communicate with the user device 302, e.g. via a wired or wireless communication link 312. The user device 302 also includes one or more output devices 314, such as a display, a speaker, and/or a haptic output mechanism.

As mentioned above, non-routine events may be identified and/or inferred via contextual data obtained from various sources, such as user device 302, second user device 338 and remote computing devices, illustrated as cloud-based services 340. Examples include contextual data 316 on user device 302, contextual data 317 on second user device 303, and contextual data 340 available from cloud-based services. Examples of contextual data 316 include calendar data 318, phone data 320, messaging data 322, email data 324, location data 326, web search history 328, user inputs 330, applications used 332, and social data 334.

Calendar data 318 may comprise information from a user's calendar (such as a personal calendar or work calendar), a national calendar (e.g. with scheduled holidays), and/or any other suitable calendars. A user's calendar may indicate travel dates, vacation dates, events such as parties, medical events (e.g. surgeries) and other non-routine events, as non-limiting examples. Phone data 320 and/or messaging data 322 may indicate whether the user has made plans for non-routine events via text message, internet searches, phone calls, and/or in other manners. Email data 324 may include information related to flight itineraries, hotel bookings, ticket purchases, parties and/or other non-routine events, as non-limiting examples.

Location data 326 may be received via one or more GPS sensors on the user device 302. In some examples, routine locations of the user may be determined according to where the user routinely goes and resides, such as home and a work location. Then, deviations from routine locations may be indicative of a non-routine event or day for the user. Location data also may be received in any other suitable manner, such as via cell phone tower information, WiFi access point information, and/or other network access point data.

Web search history 328 may provide information regarding non-routine days or events as well. For example, web search history 328 may include data regarding flights, hotels, and/or events booked by the user. Search terms entered by the user also may allow inferences of non-routine days. For example, search terms related to illness symptoms may indicate that the user is ill, while search terms related to an event may indicate that the user is attending the event.

In some instances, a user may explicitly input information regarding whether data is to be considered non-routine and/or how to treat non-routine data, as indicated in FIG. 3 by user inputs at 330. Other example sources of contextual information on user device 302 may include information regarding applications used 332, and social media data 334.

In some examples, the user device 302 and/or the wearable device 310 may upload to and/or receive information from cloud-based services, illustrated schematically at 340. Cloud-based services 340 may include user accounts with stored contextual data 346 that may be used to identify non-routine events.

The contextual data 316, 317, and 346 may be used in any suitable manner to help determine whether health data may be non-routine. For example, some contextual data, such as content-based information, may be analyzed to search for information indicating an event, whether upcoming, present, or past. As more specific examples, calendar data, email data, web search history, and other such content-based information may be analyzed for events such as trips/travel, flights, meetings, conferences, city names, and other words/phrases/content indicating that the user may be traveling. Content-based information also may be analyzed for information regarding other events, such as parties, vacations, medical events (e.g. upcoming surgeries), and any other data that may indicate a non-routine day. Such data may be correlated with sensor data, such as GPS data or other location data, to determine an actual location of the user and compare the actual location with a location indicated by content-based information. This may help to determine with more certainty whether an event is non-routine, for example, by confirming that a user is at a destination indicated in contextual airline flight data.

In some examples, contextual information related to a purpose of an event, or another characteristic of the event, may be used to determine whether the event may be non-routine. For example, calendar data 318 and/or email data 324 may indicate whether a travel occurrence is a vacation or a business meeting, as in some examples one type of travel may be considered routine and another non-routine. Further, user inputs 330 may be used to “flag” certain events and/or data associated with those events as non-routine, or to confirm determinations by the user device 302 of events/data being non-routine.

In yet other examples, non-routine events may be inferred based on sensor data. For example, sensor data may be compared to thresholds, and health data associated with contextual sensor data meeting a threshold condition may be determined to be non-routine. For example, non-routine events may be determined based on location data 326 indicating that the user has traveled over a threshold distance from a routine location (e.g. a home address or geographic place at which the user is routinely located as determined by sensor data), has been at a location for a threshold duration, and/or other threshold condition has been met.

In some examples, instead of or in addition to utilizing contextual data regarding collected health data, the health data itself may be analyzed to determine whether one or more subsets of the health data are to be considered non-routine. As non-limiting examples, raw data received from sensors 306 and/or sensors 308 may be processed to determine statistical outliers or measurements above or below a certain threshold, which may potentially indicate that the data may be non-routine. For instance, sensor data may indicate that the user's heart rate was over a threshold percentage higher on one Saturday than the user's average heart rate. The user device 302 may then, in some examples, correlate the outlying data with contextual data, e.g. calendar data 318, to determine whether or not the outlying data may be explained by a non-routine event. Continuing with the above example, calendar data may indicate that on the same Saturday, the user was attending a birthday party. The user device 302 may subsequently determine data reflecting the high heart rate as being non-routine, e.g. likely explainable by the user having attended a party, and less likely an anomaly of concern.

Data determined to be non-routine may be processed in various manners. For example, non-routine data may be disregarded, deleted, given less weight, or given separate analysis when analyzing health data. In other examples, non-routine data may be included in health analysis, but presented along with an alert indicating the data as being non-routine. For example, if non-routine data causes a user's health trend to deviate, a notification may be presented to the user indicating that the deviation may be explained by a non-routine event. As a more specific example, if the user has traveled on vacation, and has had an abnormally high number of wake-ups while sleeping during the night, the user device 302 may output an alert regarding the abnormal number of wake-ups, and in addition to the alert, output information that the anomaly may be explained by jet lag due to travel. Further, past analyses of non-routine data may be used to infer or predict health effects of future related non-routine events, and to output notifications related to such predictions (e.g. “Last time you traveled to Hawaii, your calorie consumption spiked,” “Based on information related to your last vacation, you may experience jet lag during your upcoming vacation,” etc.).

It will be understood that any other suitable data related to a user's personal life may be analyzed and determined to be non-routine besides health data, and that any other suitable type of data for which trends, correlations, anomalies, and/or other time-based analyses are applied. As a non-limiting example, the user device 302 may determine a work productivity trend of the user attending a high number of work meetings each Monday, and detect that the user has an atypically low number of work meetings next Monday compared to this trend from other Mondays. Via contextual data, the user device 302 may determine that this anomaly may be likely explained by the user being on vacation, and thus may exclude data from next Monday from work productivity trend analyses.

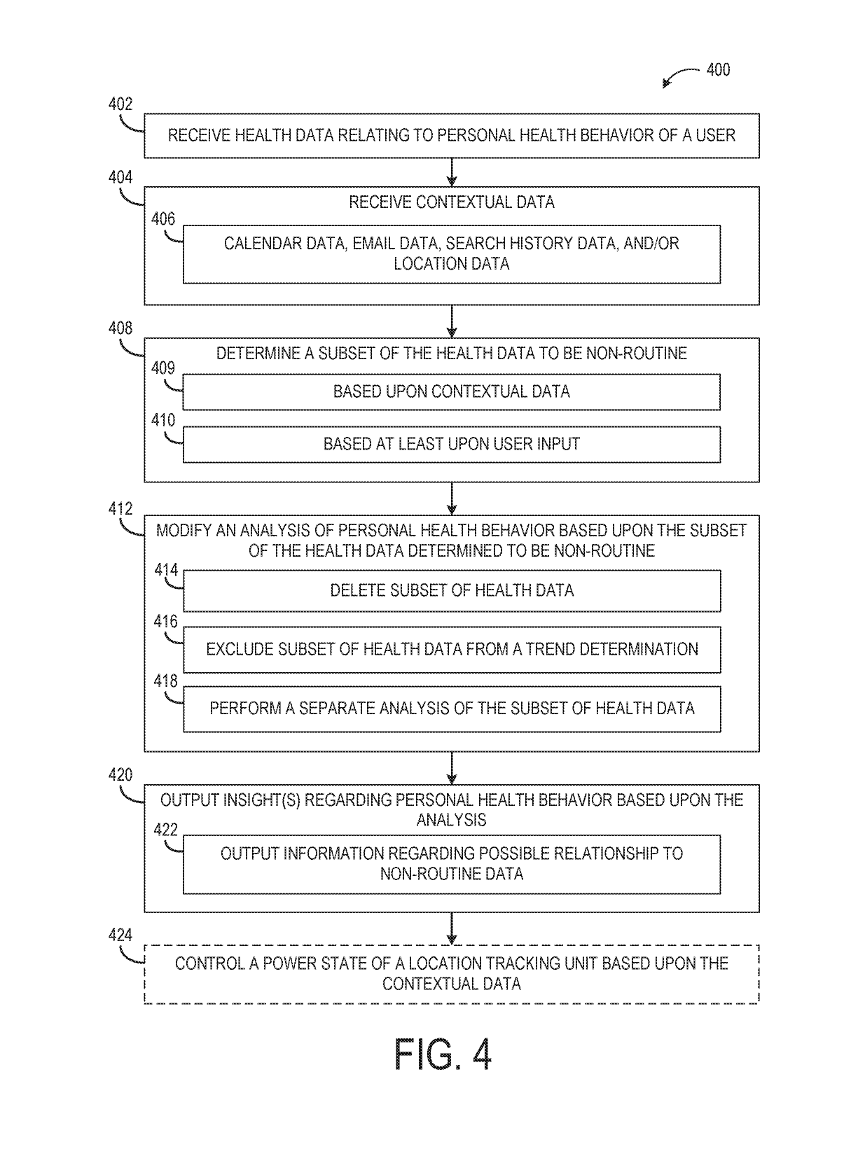

FIG. 4 shows a flow diagram depicting an example method 400 of analyzing personal behavior data based upon contextual data. Method 400 may be enacted on any suitable computing device. While disclosed in the context of health data, the method may be applied to any other suitable type of data.

Method 400 includes, at 402, receiving health data relating to personal health behavior of a user. Health data may be obtained from any suitable source, including from sensors and via user input. Sensor data may be received from sensors of one or more devices of the user, such as a smartphone, a wearable device, a tablet, a laptop computer, and/or a desktop computer. Method 400 further includes receiving contextual data, at 406. Contextual data may include, as examples, calendar data, email data, search history data, and/or location data, as shown at 406.

At 408, method 400 includes determining a subset of the health data to be potentially non-routine. The determination at 408 may be based upon the contextual data, as indicated at 409, and/or upon user input designating the data as non-routine, as indicated at 410. Where the non-routine data is determined via contextual data, the non-routine data may be determined using such data as calendar data (which may indicate non-routine events such as trips and holidays), phone messaging and/or email data (which may indicate non-routine plans), search history data (which may contain search terms relating to non-routine plans), location data (which may indicate travel away from a routine location), and/or any other suitable contextual data.

Method 400 further includes, at 412, modifying an analysis of personal health data based upon the subset of the health data determined to be non-routine. Modifying the analysis may include, at 414, deleting the subset of health data and/or, at 416, excluding the subset of health data from a trend determination, as shown and described above with regard to FIG. 1. Modifying the analysis may also include, at 418, performing a separate analysis of the subset of health data, as described above with regard to FIG. 2. Such a separate analysis may provide correlations, trends, and other insights related to the subset of health data without affecting the analysis of routine data. The analysis may be modified in any other suitable manner based upon the subset of health data determined to be non-routine.

Method 400 further includes, at 420, outputting one or more insights regarding personal health behavior based upon the analysis. Examples include but are not limited to graphical representations of trends and recommendations related to effects of non-routine events. Insights may further include information regarding a possible relationship to non-routine data, as shown at 422. For example, an annotation may be displayed along with a notification of an insight, wherein the annotation may indicate that a portion of the trend used to generate the insight may be related to a non-routine event. As non-limiting examples, poor sleep quality may be explained by traveling, or higher consumption of calories may be explained by a vacation. It will be understood that any other data in addition to health data may also be received and analyzed using contextual data, including but not limited to work productivity data, and recommendations may be output regarding any such data.

Method 400 may optionally include, at 424, controlling a power state of a location tracking unit based upon the contextual data. For example, if the contextual data indicates that the user will be traveling to a known location during a known period of time, the user device may be configured to reduce usage of or stop the operation of a GPS unit of the device during that period of time, which may help to reduce power consumption. As another example, a sleep tracking operation of the user device may be stopped during the first few days of travel, as it may be expected that the user will experience jet lag. Thus, determining collected data to be non-routine may help to conserve power, as well as to avoid unnecessary analysis of non-routine data.

In some embodiments, the methods and processes described herein may be tied to a computing system of one or more computing devices. In particular, such methods and processes may be implemented as a computer-application program or service, an application-programming interface (API), a library, and/or other computer-program product.

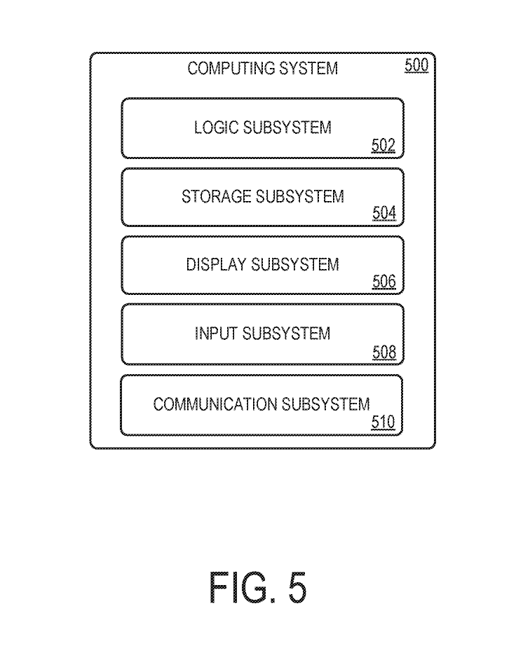

FIG. 5 schematically shows an example computing system 500 that can enact one or more of the methods and processes described above. The computing system 500 is shown in simplified form. The computing system 500 may take the form of one or more personal computers, server computers, tablet computers, home-entertainment computers, network computing devices, gaming devices, mobile computing devices, mobile communication devices (e.g., smart phone), and/or other computing devices. The various computing devices and wearable devices described earlier herein may be examples of computing system 500.

The computing system 500 includes a logic subsystem 502 and a storage subsystem 504. The computing system 500 may optionally include a display subsystem 506, input subsystem 508, communication subsystem 510, and/or other components not shown in FIG. 5.

The logic subsystem 502 includes one or more physical devices configured to execute instructions. For example, the logic subsystem 502 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem 502 may include one or more processors configured to execute software instructions. Additionally or alternatively, the logic subsystem 502 may include one or more hardware or firmware logic machines configured to execute hardware or firmware instructions. Processors of the logic subsystem 502 may be single-core or multi-core, and the instructions executed thereon may be configured for sequential, parallel, and/or distributed processing. Individual components of the logic subsystem 502 optionally may be distributed among two or more separate devices, which may be remotely located and/or configured for coordinated processing. Aspects of the logic subsystem 502 may be virtualized and executed by remotely accessible, networked computing devices configured in a cloud-computing configuration.

The storage subsystem 504 includes one or more physical devices configured to hold instructions executable by the logic subsystem 502 to implement the methods and processes described herein. When such methods and processes are implemented, the state of the storage subsystem 504 may be transformed—e.g., to hold different data.

The storage subsystem 504 may include removable and/or built-in devices. The storage subsystem 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage subsystem 504 may include volatile, nonvolatile, dynamic, static, read/write, read-only, random-access, sequential-access, location-addressable, file-addressable, and/or content-addressable devices.

It will be appreciated that storage subsystem 504 includes one or more physical devices. However, aspects of the instructions described herein alternatively may be propagated by a communication medium (e.g., an electromagnetic signal, an optical signal, etc.) that is not held by a physical device for a finite duration.

Aspects of the logic subsystem 502 and storage subsystem 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, the display subsystem 506 may be used to present a visual representation of data held by the storage subsystem 504. This visual representation may take the form of a graphical user interface (GUI). As the herein described methods and processes change the data held by the storage machine, and thus transform the state of the storage machine, the state of the display subsystem 506 may likewise be transformed to visually represent changes in the underlying data. The display subsystem 506 may include one or more display devices utilizing virtually any type of technology. Such display devices may be combined with the logic subsystem 502 and/or storage subsystem 504 in a shared enclosure, or such display devices may be peripheral display devices.

When included, the input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, the communication subsystem 510 may be configured to communicatively couple the computing system 500 with one or more other computing devices. The communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow the computing system 500 to send and/or receive messages to and/or from other devices via a network such as the Internet.

Another example provides a computing device comprising a logic subsystem comprising a logic device, and a storage subsystem comprising a storage device and instructions executable by the logic subsystem to receive personal data relating to personal behavior of a user, receive contextual data regarding the personal data, determine a subset of the personal data to be non-routine based upon the contextual data, and modify an analysis of personal behavior based upon the subset of the personal data determined to be non-routine. The contextual data may additionally or alternatively include one or more of calendar data, email data, search history data, and location data. The instructions may be additionally or alternatively executable to modify the analysis of personal behavior by giving less weight to the subset of personal data in the analysis of personal behavior. The instructions may be additionally or alternatively executable to exclude the subset of the personal data determined to be non-routine from a trend determination. The instructions may be additionally or alternatively executable to modify the analysis of personal behavior by performing a separate analysis of the subset of the personal data determined to be non-routine. The instructions may be additionally or alternatively executable to output one or more insights regarding personal health behavior based upon the analysis and also output information regarding a possible relationship of the insight to non-routine data. The instructions may be additionally or alternatively executable to determine the subset of the personal data to be non-routine based at least upon user input. The instructions may be additionally or alternatively executable to control a power state of the computing device based upon the contextual data.

Another example provides, on a computing device, a method comprising receiving health data relating to personal health behavior of a user, receiving contextual data regarding the health data, determining a subset of the health data to be non-routine based upon the contextual data, and modifying an analysis of personal health behavior based upon the subset of the health data determined to be non-routine. The contextual data may additionally or alternatively include one or more of calendar data, email data, search history data, and location data. Modifying the analysis of personal health behavior may additionally or alternatively include removing the subset of the health data from the analysis of personal health behavior. The method may additionally or alternatively include excluding the subset of health data determined to be non-routine from a trend determination. Modifying the analysis of personal health behavior comprises performing a separate analysis of the subset of the health data determined to be non-routine. The method may additionally or alternatively include outputting one or more recommendations regarding personal health behavior based upon the analysis. Determining the subset of the health data to be non-routine may additionally or alternatively include determining the subset of the health data to be non-routine based at least upon user input.

Another example provides a computing device comprising a logic subsystem comprising a logic device, and a storage subsystem comprising a storage device and instructions executable by the logic subsystem to receive health data relating to personal health behavior of a user, receive contextual data regarding the health data, determine a subset of the health data to be non-routine based upon the contextual data, and perform an analysis of personal health behavior while excluding the subset of the health data determined to be non-routine from the analysis. The contextual data may additionally or alternatively include one or more of calendar data, email data, search history data, and location data. The instructions may be additionally or alternatively executable to exclude the subset of the health data determined to be non-routine from a trend determination. The instructions may be additionally or alternatively executable to perform a separate analysis of the subset of the health data determined to be non-routine. The instructions may be additionally or alternatively executable to output one or more recommendations regarding personal health behavior based upon the analysis.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising
a logic subsystem comprising a logic device; and
a storage subsystem comprising a storage device and instructions executable by the logic subsystem to
receive personal data relating to personal behavior of a user;
receive contextual data regarding the personal data;
determine a subset of the personal data to be non-routine based upon the contextual data; and
modify an analysis of personal behavior based upon the subset of the personal data determined to be non-routine.

2. The computing device of claim 1, wherein the contextual data comprises one or more of calendar data, email data, search history data, and location data.

3. The computing device of claim 1, wherein the instructions are executable to modify the analysis of personal behavior by giving less weight to the subset of personal data in the analysis of personal behavior.

4. The computing device of claim 1, wherein the instructions are further executable to exclude the subset of the personal data determined to be non-routine from a trend determination.

5. The computing device of claim 1, wherein the instructions are executable to modify the analysis of personal behavior by performing a separate analysis of the subset of the personal data determined to be non-routine.

6. The computing device of claim 1, wherein the instructions are executable to output one or more insights regarding personal health behavior based upon the analysis and also output information regarding a possible relationship of the insight to non-routine data.

7. The computing device of claim 1, wherein the instructions are executable to determine the subset of the personal data to be non-routine based at least upon user input.

8. The computing device of claim 1, wherein the instructions are executable to control a power state of the computing device based upon the contextual data.

9. On a computing device, a method comprising
receiving health data relating to personal health behavior of a user;
receiving contextual data regarding the health data;
determining a subset of the health data to be non-routine based upon the contextual data; and
modifying an analysis of personal health behavior based upon the subset of the health data determined to be non-routine.

10. The method of claim 9, wherein the contextual data comprises one or more of calendar data, email data, search history data, and location data.

11. The method of claim 9, wherein modifying the analysis of personal health behavior comprises removing the subset of the health data from the analysis of personal health behavior.

12. The method of claim 11, further comprising excluding the subset of health data determined to be non-routine from a trend determination.

13. The method of claim 9, wherein modifying the analysis of personal health behavior comprises performing a separate analysis of the subset of the health data determined to be non-routine.

14. The method of claim 9, further comprising outputting one or more recommendations regarding personal health behavior based upon the analysis.

15. The method of claim 9, wherein determining the subset of the health data to be non-routine comprises determining the subset of the health data to be non-routine based at least upon user input.

16. A computing device comprising
a logic subsystem comprising a logic device; and
a storage subsystem comprising a storage device and instructions executable by the logic subsystem to
receive health data relating to personal health behavior of a user;
receive contextual data regarding the health data;
determine a subset of the health data to be non-routine based upon the contextual data; and
perform an analysis of personal health behavior while excluding the subset of the health data determined to be non-routine from the analysis.

17. The computing device of claim 16, wherein the contextual data comprises one or more of calendar data, email data, search history data, and location data.

18. The computing device of claim 16, wherein the instructions are further executable to exclude the subset of the health data determined to be non-routine from a trend determination.

19. The computing device of claim 16, wherein the instructions are further executable to perform a separate analysis of the subset of the health data determined to be non-routine.

20. The computing device of claim 16, wherein the instructions are executable to output one or more recommendations regarding personal health behavior based upon the analysis.
